(19) United States
(12) Patent Application Publication
(10) Pub. No.: US 2025/0013912 A1
(43) Pub. Date: Jan. 9, 2025

(54) MULTITASK MACHINE LEARNING USING DISJOINT DATASETS

(71) Applicant: QUALCOMM Incorporated, San Diego, CA (US)

(72) Inventors: Teo Desmond Per Siki Amon Lee JANSSON MINNE, Stockholm (SE); Saeed DABBAGHCHIAN, Bromma (SE); Mohammadreza MALEK-MOHAMMADI, Solna (SE)

(21) Appl. No.: 18/346,374

(22) Filed: Jul. 3, 2023

(51) Int. Cl. G06N 20/00

(52) U.S. Cl. CPC G06N 20/00

(57) ABSTRACT

Certain aspects of the present disclosure provide techniques and apparatus for improved machine learning. A first dataset comprising one or more labeled exemplars for a first machine learning task and a second dataset comprising one or more labeled exemplars for a second machine learning task are accessed. A combined loss is generated based on the first and second datasets, comprising generating a supervised loss for the first machine learning task based on the one or more labeled exemplars from the first dataset, and generating a self-supervised loss for the first machine learning task based on the one or more labeled exemplars from the second dataset. One or more parameters of a multitask machine learning model are updated based on the combined loss.

### INTRODUCTION

Aspects of the present disclosure relate to machine learning.

Multitask learning, where a single machine learning model (e.g., a neural network) is trained to perform multiple tasks, has become increasingly useful in a variety of environments (e.g., in autonomous driving applications). Generally, supervised training of a multitask model demands large amounts of multi-labeled ground truth data (e.g., where each input sample has multiple labels or ground truths-one for each desired task). Labeled data (even for a single task) is generally difficult and/or expensive to obtain (e.g., it is often not feasible to generate highly granular ground truth for depth estimation tasks). As such, multi-labeled data is virtually non-existent in most scenarios. Additionally, when such multi-labeled data can be created, this data is generally very expensive in terms of cost and computational resources used. Further, in some conventional systems, new features or tasks cannot be added or learned without a massive re-gathering of such multi-labeled data.

### BRIEF SUMMARY

Certain aspects provide a method, comprising: accessing a first dataset comprising one or more labeled exemplars for a first machine learning task; accessing a second dataset comprising one or more labeled exemplars for a second machine learning task; generating a combined loss based on the first and second datasets, comprising generating a first supervised loss for the first machine learning task based on the one or more labeled exemplars from the first dataset; and generating a first self-supervised loss for the first machine learning task based on the one or more labeled exemplars from the second dataset; and updating one or more parameters of a multitask machine learning model based on the combined loss.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 illustrates an example environment for multitask machine learning using disjoint datasets.

FIG. 2 illustrates an example workflow for multitask training using disjoint datasets.

FIG. 3 depicts an example workflow for self-supervised training in disjoint multitask learning.

FIG. 4 is a flow diagram depicting an example method for training multitask machine learning models using disjoint datasets.

FIG. 5 is a flow diagram depicting an example method for aggregating losses to train multitask machine learning models using disjoint datasets.

FIG. 6 is a flow diagram depicting an example method for training a multitask machine learning model.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and computer-readable mediums for multitask machine learning models based on disjoint datasets.

In some conventional approaches, supervised learning can be used to train multitask models. However, such supervised approaches often rely on training (and evaluation) data with ground truth annotations for all tasks to be learned by the model. As the quantity and quality of training data often has a vital impact on model performance, this reliance on multi-labeled data is a major limiting factor. Collecting and labeling such data is generally a costly (and impractical) process, in particular for certain tasks such as depth estimation and keypoint detection.

In some aspects of the present disclosure, a combination of task disjoint datasets are used to train a multitask machine learning model. As used herein, disjoint datasets refer to datasets that are at least partially non-overlapping (e.g., one or more exemplars in a first disjoint dataset are not present in a second disjoint dataset), where each of the disjoint datasets corresponds to or has labels for a respective machine learning task. That is, each disjoint dataset may have similar input features (e.g., image data) but differing output features (e.g., depth estimation as opposed to semantic segmentation). Stated differently, one dataset may comprise training data (e.g., images with ground truth labels) for a first task, while a second dataset comprises training data (e.g., images with ground truth labels) for a second (different) task. In some aspects, one or more of the training datasets may be partially joint with respect to some tasks (e.g., including labels for two or more tasks) while remaining disjoint from one or more other tasks (e.g., lacking labels for the other task(s)).

As used herein, a task generally refers to content of the predictions or output of the model. For example, one task may correspond to estimating depth from images, while a second task may correspond to identifying objects in images. As one example of disjoint datasets and tasks that can be leveraged using aspects of the present disclosure, a semantic segmentation dataset (e.g., images, each with a ground truth segmentation map for one or more pixels in the image) and a monocular depth estimation dataset (e.g., images, each with a ground truth depth estimate for one or more pixels in the image) may be used to train a multitask machine learning model that can perform both semantic segmentation and depth estimation based on input images.

Some conventional solutions fail to enable multitask training using such disjoint datasets due to a variety of concerns, including catastrophic interference or forgetting (when the model abruptly and drastically forgets previously learned tasks when being trained on a new task). However, aspects of the present disclosure enable use of such disjoint datasets without these concerns, resulting in substantially improved model performance. For example, a wide variety of existing (disjoint) datasets corresponding to various tasks may be leveraged to train a multitask model to perform all of the tasks. Such applications are simply not possible in conventional approaches that rely on joint (e.g., multi-label) datasets (e.g., datasets collected expressly for training the present model).

In some aspects, a combination of supervised and self-supervised learning is used to train multitask machine learning models using disjoint datasets. For example, exemplars from a given dataset (corresponding to a given task) may be used to provide supervised training for that given task, and may further be used to provide unsupervised or self-supervised training for one or more other tasks. As one example, a segmentation dataset can provide (true) supervision for the segmentation task and self-supervision (e.g., supervision without true labels) for the depth task. Additionally, a depth dataset can provide supervision for the depth task and self-supervision for the segmentation task. This may substantially improve the flexibility and accuracy of the trained multitask model, may reduce computational and other expenses in collecting training data, and/or may generally improve the training process (as well as improving any downstream systems that use such trained models, such as for autonomous driving).

In some aspects discussed herein, computer vision (CV) tasks are used as example tasks that can be performed by a multitask machine learning model. For example, a multitask model may be trained to perform at least one of monocular depth estimation (e.g., estimating depth of each pixel in a single image), semantic segmentation (e.g., predicting the semantic meaning of each pixel, such as whether each pixel depicts a pedestrian, a tree, a vehicle, and the like), object detection (e.g., generating bounding polygons around objects such as vehicles), surface normal estimation (e.g., estimating the surface normal of the object depicted by each pixel), and/or edge detection (e.g., detecting edges depicted in the images). However, aspects of the present disclosure are readily applicable to a wide variety of machine learning tasks. For example, in addition to computer vision, learning for other dense prediction tasks (e.g., tasks where the desired prediction or output is dense and/or structured in time and/or space) such as some natural language processing (NLP) tasks can be performed using aspects of the present disclosure.

### Example Environment for Multitask Machine Learning Using Disjoint Datasets

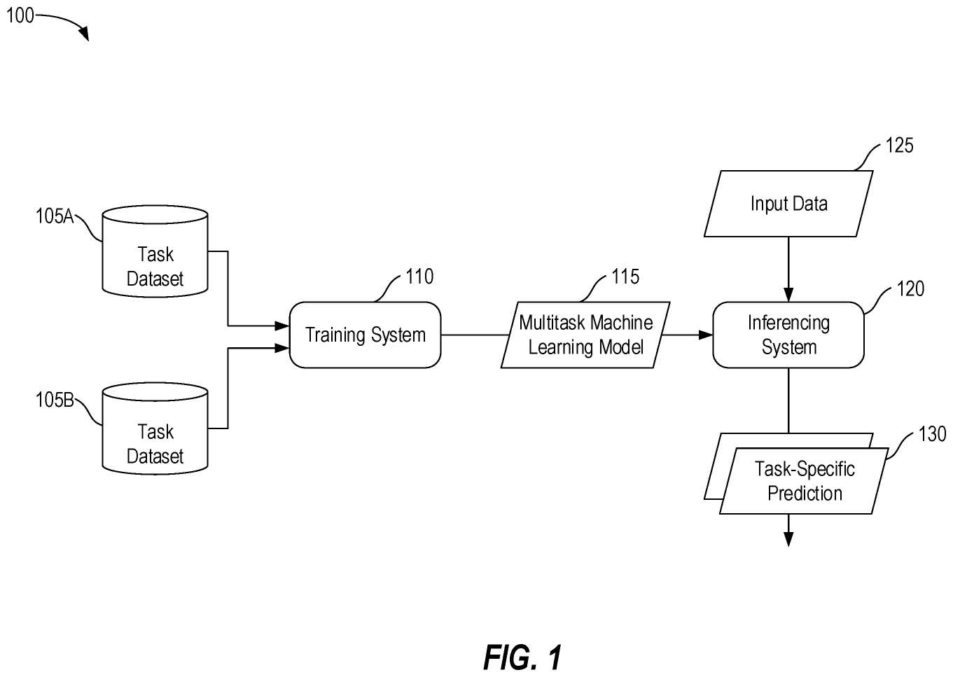

FIG. 1 illustrates an example environment 100 for multitask machine learning using disjoint datasets.

In the illustrated example, a set of task datasets 105A and 105B (collectively, task datasets 105) are used by a training system 110 to train a multitask machine learning model 115. In some aspects, each task dataset 105 comprises training data (e.g., exemplars) for one or more machine learning tasks. In some aspects, although the content of the target output or labels differ across different task datasets 105, the input portion of each exemplar may generally include corresponding content (e.g., the input for each exemplar in task dataset 105 may be an image). That is, each exemplar included within a given task dataset 105 may include input data (e.g., an image) as well as one or more labels (e.g., ground truth data) for one or more tasks. For example, the task dataset 105A may include images with semantic segmentation labels, while the task dataset 105B may include different images with pixel depth labels. In some aspects, the task datasets 105 are disjoint in that the datasets correspond to or have labels for different tasks (e.g., the images in the task dataset 105A have labels relevant to a first task, but do not have labels relevant to a second task that corresponds to the task dataset 105B).

That is, the task dataset 105A includes labels for a first machine learning task and does not include labels for a second machine learning task, while the task dataset 105B includes labels for the second machine learning task and does not include labels for the first machine learning task. In some aspects, one or more of the task datasets 105 may be partially joint. For example, the task dataset 105A may include labels for two tasks (e.g., for segmentation and object detection), while the task dataset 105B includes labels for another task (e.g., for depth estimation). Additionally, although two task datasets 105 are depicted for conceptual clarity, there may be any number of task datasets 105 (and any number and variety of tasks).

In aspects, the training system 110 may be implemented as a discrete system or as a component of one or more other systems, and may be implemented using software, hardware, or a combination of software and hardware. In some aspects, as discussed in more detail below, the training system 110 uses a combination of supervised and self-supervised training to train the multitask machine learning model 115. For example, the exemplars from the task dataset 105A (corresponding to a first machine learning task) may be used to provide supervisory signals for the first task, while exemplars from the task dataset 105B (corresponding to a second machine learning task) may be used to provide supervisory signals for the second task. Further, exemplars from the task dataset 105A may be used to provide additional self-supervisory signals for the second task, while exemplars from the task dataset 105B can further be used to provide additional self-supervisory signals for the first task.

That is, for each machine learning task reflected by one or more task datasets 105 (e.g., for each task that the training system 110 is training the multitask machine learning model 115 to perform), the training system 110 may use any available data that is labeled for the task (e.g., from a single task dataset 105) for supervised training with respect to the task, as well as using the remaining data that is not labeled for the task (e.g., from other task datasets 105) for self-supervised training with respect to the task. This approach can provide substantial improvements in prediction robustness and model accuracy for the given task, while maintaining minimal (or no) reduction in performance for other tasks (e.g., preventing catastrophic forgetting).

After being so trained, in the illustrated example, the training system 110 deploys or provides the multitask machine learning model 115 for inferencing (e.g., to an inferencing system 120). Although depicted as deploying the multitask machine learning model 115 to a separate discrete system, in some aspects, the training system 110 may itself use the multitask machine learning model 115 for inferencing. Generally, deploying the multitask machine learning model 115 may include any operations to prepare or provide the model for runtime use, such as providing the architecture details, learned weight(s), and any other data used to instantiate a copy of the model.

In the illustrated example, the inferencing system 120 uses the trained multitask machine learning model 115 to process input data 125 in order to generate task-specific predictions 130. In aspects, the inferencing system 120 may be implemented as a discrete system or as a component of one or more other systems, and may be implemented using software, hardware, or a combination of software and hardware.

As discussed above and below, the multitask machine learning model 115 is generally trained to receive input data and generate a variety of output predictions (e.g., a prediction for each task). For example, in the case of computer vision tasks, the multitask machine learning model 115 may be trained to receive input images and generate corresponding depth maps, segmentation maps, object detections, and the like. In some aspects, the multitask machine learning model 115 generates a prediction for each task whenever input data is received. In some aspects, the multitask machine learning model 115 is instructed as to which output is desired (e.g., along with providing input data such as an image, the requesting entity can also indicate what task(s) should be performed).

Generally, the multitask machine learning model 115 can correspond to a variety of architectures depending on the particular implementation. For example, in some aspects, the multitask machine learning model 115 is implemented using a convolutional neural network (CNN). In some aspects, the multitask machine learning model 115 is a fully convolutional network (FCN), which is a modification of a CNN to enable dense predictions tasks. For example, while CNNs may generally include fully connected final layers, the FCN may instead remove the fully connected final output layer(s), replace any other fully connected layers with convolutional layers, and use processes such as upsampling and/or transposed convolution to convert the output of the final layer into a dense pixel-wise prediction.

As another example, the multitask machine learning model 115 may be implemented using an encoder-decoder architecture. Encoder-decoder architectures generally consist of one or more encoders and one or more decoders. In some aspects, the encoder comprises a series of convolutional and pooling layers that downsample the input image to generate encoded features, while the decoder comprises a series of convolutional and upsampling layers that upsample the encoded features to generate an output prediction map (e.g., a segmentation map or depth map). In some aspects, the multitask machine learning model 115 comprises a single shared encoder (shared across tasks) and a respective decoder for each respective task.

In some aspects, the content and format of the input data 125 may vary depending on the particular implementation, but generally corresponds to the exemplars in the task datasets 105. For example, if the training exemplars in the task datasets 105 used image data as input, the input data 125 may similarly be image data.

In some aspects, for example, the inferencing system 120 is a component of an autonomous (or semi-autonomous vehicle), such as a self-driving car. In some aspects, the input data 125 may be collected from the environment (e.g., cameras on the vehicle) and used to generate task-specific predictions 130 (e.g., depth maps and segmentation maps) to guide the navigation or movement of the vehicle.

For example, the inferencing system 120 may be used to provide, enable, or enhance Advanced Driver Assistance Systems (ADAS) which may conventionally utilize powerful models (e.g., deep neural networks) capable of handling computer vision tasks to improve safety in traffic and move towards fully autonomous driving (AD). Some conventional approaches in such fields utilize very large deep neural networks with impressive expressiveness. However, such conventional approaches are generally limited to using a set of single-task models, which substantially increases computational expense of generating the desired predictions. For deployments such as AD and/or ADAS systems (or other resource-constrained systems), the mobile/embedded devices used in the vehicles are often limited in terms of computational power and memory. Nevertheless, the tasks generally must be performed rapidly in a real-time fashion (e.g., 15-60 frames per second).

In some aspects, by instead using the multitask machine learning model 115, the computational resources consumed can be substantially reduced (as compared to using multiple task-specific models).

As discussed above, each task-specific prediction 130 generally comprises an output prediction for a given machine learning task. For example, one task-specific prediction 130 may comprise semantic segmentation predictions for the image (e.g., indicating the semantic class of the object(s) depicted by each pixel in an input image), while a second task-specific prediction 130 may comprise depth estimations for each pixel in the image and a third task-specific prediction 130 comprises bounding polygons for objects detected in the input image.

These task-specific predictions 130 can then be used to perform a wide variety of operations, such as autonomous navigation. In this way, the multitask machine learning model 115 is able to provide robust and reliable predictions for a variety of tasks. Because the model can be trained using a variety of disjoint datasets, which substantially improves the number and variety of training samples, the model generally exhibits substantially improved robustness and accuracy, as compared to conventional multitask approaches. Further, by using multitask models rather than task-specific models, the multitask machine learning model 115 generally consumes substantially reduced resources, as compared to conventional single-task approaches.

### Example Workflow for Multitask Training Using Disjoint Datasets

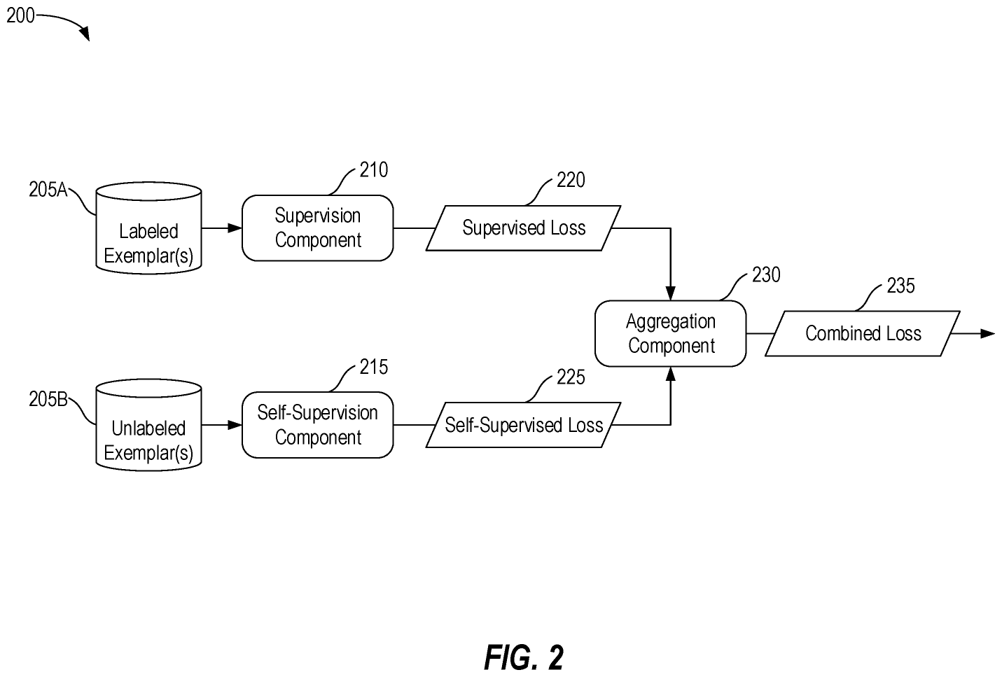

FIG. 2 illustrates an example workflow 200 for multitask training using disjoint datasets. In some aspects, the workflow 200 is performed by a training system, such as the training system 110 of FIG. 1.

In the illustrated example, labeled exemplars 205A and unlabeled exemplars 205B are used to generate a combined loss 235. As used herein, whether an exemplar is “labeled” or “unlabeled” may be defined with respect to particular machine learning tasks. That is, an exemplar may be referred to as “labeled” with respect to one or more machine learning tasks to indicate that the exemplar comprises a label or ground truth for the specific task(s). This same exemplar may be referred to as “unlabeled” with respect to one or more other machine learning tasks to indicate that the exemplar lacks such ground truth for the other task(s). For example, an image with depth information may be a labeled exemplar 205A with respect to a depth estimation task while serving as an unlabeled exemplar 205B with respect to a semantic segmentation task.

In some aspects, the workflow 200 is performed for each respective task (for which the model is being trained) to generate the corresponding or respective combined loss 235 for the task. For example, if the model is being trained to perform two tasks, two combined losses 235 may be generated (one for each task). In some aspects, the combined losses 235 may themselves be combined into an overall loss for the model. In some aspects, the multitask model (e.g., the multitask machine learning model 115 of FIG. 1) may be refined or updated using some or all of these combined losses 235 separately or in combination, as discussed in more detail below.

For example, suppose that the task dataset 105A of FIG. 1 corresponds to a first task. To generate a loss for this first task, the exemplars from the task dataset 105A may be used as the labeled exemplars 205A. To generate a loss for the first task, the exemplars from the task dataset 105B may be used as the unlabeled exemplars 205B. Similarly, to generate a loss for a second task, the task dataset 105A may be used as the unlabeled exemplars 205B, while the task dataset 105B is used as the labeled exemplars 205A. In some aspects, each training iteration is delineated into N stages (for N tasks). At each stage (e.g., for each task), the training system can sample a batch of the labeled exemplars 205A (from the task dataset corresponding to the current task) and a batch of the unlabeled exemplars 205B (from other task dataset(s)). Multiple such iterations (updating the model based on batches of data each time) may then be repeated for each epoch of training.

In the illustrated example, the labeled exemplars 205A are than used by a supervision component 210 to generate a supervised loss 220. For example, for each exemplar in the labeled exemplars 205A, the input features (e.g., images) may be processed by the model (e.g., the multitask machine learning model 115 of FIG. 1) to generate an output prediction (e.g., the task-specific prediction 130 of FIG. 1) for the current task to which the labeled exemplar 205A corresponds. This output prediction can then be used, in conjunction with the label of the exemplar, to generate the supervised loss 220. Generally, a wide variety of supervised loss formulations may be used. For example, the training system may use a cross-entropy loss formulation. In the illustrated example, the supervision component 210 performs such operations for each labeled exemplar 205A to generate the overall supervised loss 220 (e.g., by averaging or summing the individual losses for each individual sample).

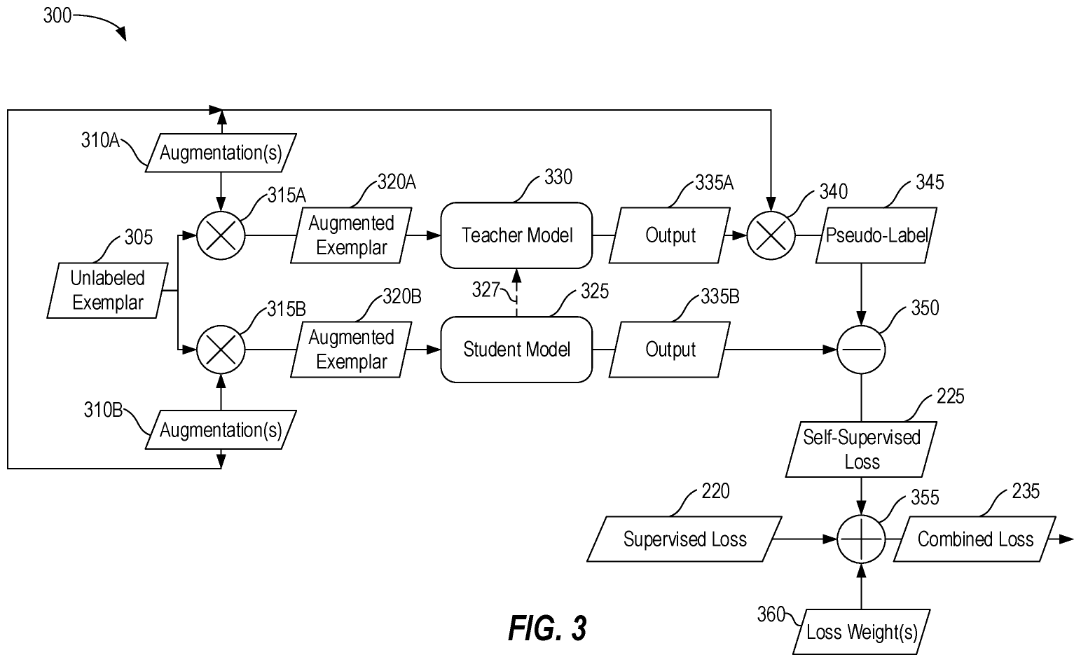

Additionally, as illustrated, the unlabeled exemplars 205B are used by a self-supervision component 215 to generate a self-supervised loss 225. Generally, a wide variety of self-supervised loss formulations may be used. For example, in some aspects, the training system may process each exemplar in the unlabeled exemplars 205B using the machine learning model to generate an output, comparing this output against a pseudo-label generated by a teacher or other model, as discussed below in more detail with reference to FIG. 3. In the illustrated example, the self-supervision component 215 performs such operations for each unlabeled exemplar 205B to generate the overall self-supervised loss 225 (e.g., by averaging or summing the individual losses for each individual sample).

As illustrated, the supervised loss 220 and the self-supervised loss 225 are then processed by an aggregation component 230 to generate the combined loss 235 for the task or stage. For example, the aggregation component may compute a weighted sum of the losses. In some aspects, the combined loss 235 for a given task n is defined using Equation 1 below, where [symbol] _{combined,n} is the combined loss for task n, [symbol] _{supervised,n} is the supervised loss 220 for task n, λ_{SSL,n} is a self-supervised weight parameter (or hyperparameter) for task n, and [symbol] _{SSL,n} is the self-supervised loss 225 for task n:

$${ℒ}_{combined , n} = {ℒ}_{supervised , n} + {λ}_{SSL , n} {ℒ}_{SSL , n} \qquad ( 1 )$$

In some aspects, the weight of the self-supervised loss λ_{SSL,n} may be defined using a warm-up technique where the value of the weight is dependent on the current epoch or iteration of training. For example, during early epochs, the weight of the self-supervised loss may be relatively low (e.g., due to the fact that the model likely does not produce particularly reliable predictions at these early epochs). During training, the weight may be increased each epoch until the weight is at a defined maximum in the final epoch (when the self-supervisory signals are likely to be more reliable).

In some aspects, the combined loss 235 for the current task can then be used to refine or update the parameters of the machine learning model (e.g., using backpropagation). The training system may then proceed to the next stage (e.g., the next task) and repeat the workflow 200. In other aspects, the combined loss 235 for the current task may be retained and combined with the combined losses from other tasks, and the overall loss may then be used to refine the model. For example, in some aspects, the overall loss may be defined using Equation 2 below, where [symbol] ₒᵥₑᵣₐₗₗ is the overall loss, N is the number of tasks, λᵢ is the task-specific weight of the i-th task, and [symbol] _{combined,i} is the combined loss 235 of the i-th task (including both the supervised loss 220 and the self-supervised loss 225):

$${ℒ}_{overall} = {\sum }_{i = 1}^{N} {λ}_{i} {ℒ}_{combined , i} \qquad ( 2 )$$

In some aspects, the task-specific weight is a hyperparameter, which may have a fixed or constant value during training. In some aspects, the overall loss may alternatively be given by Equation 3 below, where λ_{SSL} is a self-supervision weight (which may be unique to each task or may be shared across tasks), M is the number of tasks that receive or use self-supervision, λⱼ is task-specific weight of task j, and [symbol] _{SSL,j} is the self-supervised loss of task j:

$${ℒ}_{overall} = {\sum }_{i = 1}^{N} {λ}_{i} {ℒ}_{supervised , i} + {λ}_{SSL} {\sum }_{j = 1}^{M} {λ}_{j} {ℒ}_{SSL , j} \qquad ( 3 )$$

The combined or overall loss (representing the combined loss from each task) can then be used to update the parameters of the model, such as by using backpropagation. By using a combination of supervised learning and self-supervised learning, the training system can effectively treat disjoint datasets as a single (larger) partially annotated set (with labels on only some exemplars). In this way, the training system can leverage disjoint datasets to train the multitask model without catastrophic forgetting.

### Example Workflow for Self-Supervised Training in Disjoint Multitask Learning

FIG. 3 depicts an example workflow 300 for self-supervised training in disjoint multitask learning. In some aspects, the workflow 300 is performed by a training system, such as the training system 110 of FIG. 1. In some aspects, the workflow 300 provides additional detail for the operations of the self-supervised component 215 and the aggregation component 230, each of FIG. 2.

In the illustrated example, an unlabeled exemplar 305 (e.g., from the unlabeled exemplars 205B of FIG. 2) undergoes augmentation operations 315A and 315B to generate augmented exemplars 320A and 320B. The augmentation operations 315A and 315B (collectively, augmentation operations 315) generally correspond to the application of one or more transformations or modifications to the unlabeled exemplar 305, such as cropping, rotation, translation, inversion, skewing, scaling, adding or removing noise, adding obfuscations or overlays, and the like. In the illustrated example, each augmentation operation 315A and 315B is performed based on a corresponding set of augmentations 310A and 310B, respectively.

In some aspects, the augmentations 310A and 310B (collectively, augmentations 310) are selected randomly or pseudo-randomly. For example, the training system (or another component) may generate each set of the augmentations 310A and 310B by randomly selecting one or more transformation operations or types, and/or randomly selecting a magnitude of each selected transformation. In some aspects, the set of augmentations 310A may generally be selected to result in less augmentation or modification, as compared to the augmentations 310B. For example, in selecting the augmentations 310A, the training system may select fewer transformations, select from a smaller set of possible transformations, select smaller magnitudes (e.g., with a lower maximum threshold for each transformation), and the like. The augmentations 310A and 310B may generally be selected (randomly) independently from each other, as well as independently for each unlabeled exemplar 305.

In the illustrated example, the augmented exemplar 320A is then provided to a teacher model 330, while the augmented exemplar 320B is provided to a student model 325. In some aspects, the student model 325 corresponds to all or a subset of the multitask machine learning model 115 of FIG. 1. For example, the student model 325 may correspond to the (shared) encoder and at least the task-specific decoder that is being refined based on the unlabeled exemplar 305.

In some aspects, as illustrated by operation 327, the teacher model 330 is generated based on the student model 325. For example, the teacher model 330 may be the exponential moving average of the student model 325. That is, the parameters of the teacher model 330 in a given training stage or step may be a weighted (e.g., exponentially weighted) average of the parameters of the student model 325 over one or more training stages (e.g., a weighted average of the parameters in the current stage and one or more prior stages). This may be referred to in some aspects as a “Mean Teacher” approach, which allows the teacher model 330 to provide improved supervision.

In the illustrated workflow 300, the teacher model 330 generates an output 335A based on the augmented exemplar 320A, and the student model 325 outputs an output 335B based on the augmented exemplar 320B. The output 335A of the teacher model 330 is then processed using operation 340 to generate a pseudo-label 345 for the unlabeled exemplar 305. As illustrated, the operation 340 uses the previously generated set of augmentations 310A and 310B for the unlabeled exemplar 305 to generate the pseudo-label 345. For example, in some aspects, the operation 340 applies the inverse of the augmentations 310A (to undo the transformations applied to generate the augmented exemplar 320A) and further applies the augmentations 310B (which were used to create the augmented exemplar 320B) to cause the pseudo-label 345 to match or align with the output 335B of the student model 325.

In the illustrated example, the output 335B and pseudo-label 345 are then processed by operation 350 to generate the self-supervised loss 225. In aspects, the operation 350 may generally correspond to a wide variety of supervised loss formulations, using the pseudo-label 345 as a ground truth. For example, the operation 350 may correspond to a cross-entropy loss formulation between the pseudo-label 345 and the output 335B.

In the illustrated example, the self-supervised loss 225 is then aggregated, by operation 355, with the supervised loss 220 based on a set of loss weights 360 to generate the combined loss 235. In some aspects, as discussed above, the loss weights 360 can generally include one or more task-specific weights (which may be fixed or constant during training) and/or one or more self-supervised weights (which may have values that change over different iterations or epochs, such as by starting at a first defined value and increasing linearly or exponentially to a second defined value).

As discussed above, this combined loss 235 can then be used to update the parameters of the student model 325 (in isolation, such as using stochastic gradient descent based on a single exemplar, or in batches using batch gradient descent), as discussed above.

### Example Method for Training Multitask Machine Learning Models Using Disjoint Datasets

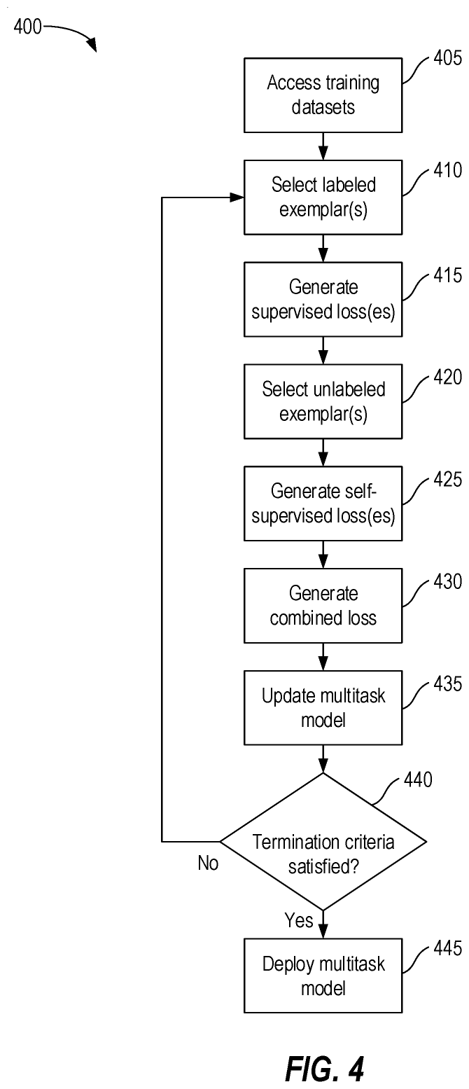

FIG. 4 is a flow diagram depicting an example method 400 for training multitask machine learning models using disjoint datasets. In some aspects, the method 400 is performed by a training system, such as the training system 110 of FIG. 1.

At block 405, the training system accesses one or more training datasets (e.g., the set of task datasets 105 of FIG. 1). As used herein, “accessing” data generally includes receiving, retrieving, obtaining, requesting, collecting, generating, or otherwise gaining access to the data. For example, the training datasets may be received or retrieved from one or more remote repositories or systems. As discussed above, in some aspects, each exemplar in the training datasets has one or more labels indicating a ground truth or target for one or more machine learning tasks. In some aspects, some of the exemplars may have no such labels. For example, some samples may be used only for self-supervised training of one or more tasks, without being used to provide true supervision of any tasks.

At block 410, the training system selects a set of labeled exemplars with respect to a given task for which the model is being trained. For example, the training system may select a depth estimation task and therefore select the exemplars from a corresponding task dataset that includes depth labels. In some aspects, the training system selects all available data labeled for the given task. In some aspects, the training system selects a batch of samples from the dataset. Generally, if a subset or batch is selected, the training system may use any suitable technique or criteria, including random sampling, to select the labeled exemplars.

At block 415, the training system generates supervised loss(es) (e.g., the supervised loss 220 of FIG. 2) for the given task based on the labeled exemplars, as discussed above. For example, the training system may compute a cross-entropy loss between a predicted output (generated by processing the input of each exemplar using the model) and the corresponding label for each exemplar.

At block 420, the training system selects a set of unlabeled exemplars with respect to the given task. For example, the training system may select exemplars from one or more task datasets that do not correspond to or include labels for the given task. In some aspects, the training system selects all available data that is not labeled for the given task. In some aspects, the training system selects a batch of samples from the unlabeled datasets. Generally, if a subset or batch is selected, the training system may use any suitable technique or criteria, including random sampling, to select the unlabeled exemplars.

At block 425, the training system generates self-supervised loss(es) (e.g., the self-supervised loss 225 of FIG. 2) for the given task based on the unlabeled exemplars, as discussed above. For example, the training system may use the workflow 300 to generate a pseudo-label for each unlabeled exemplar, and compute a cross-entropy loss based on this pseudo-label.

At block 430, the training system generates a combined loss (e.g., the combined loss 235 of FIG. 2) based on the supervised loss(es) and self-supervised loss(es). For example, as discussed above, the training system may compute a weighted sum of the supervised and self-supervised losses to generate the combined loss. As discussed above, this weighted sum may be generated based on task-specific weights and/or self-supervision weights.

At block 435, the training system updates the multitask model based on the combined loss, such as using backpropagation, as discussed above.

At block 440, the training system determines whether one or more termination criteria are met. Generally, the termination criteria may correspond to a variety of evaluations. For example, the training system may determine whether additional training data remains, whether a defined number of training rounds (e.g., stages in an iteration, iterations in an epoch, and/or epochs in training) have been completed, whether a desired accuracy has been reached, whether a defined amount of computing resources or time has been spent, and the like. For example, the training system may determine whether all of the stages in the current iteration have been completed (e.g., whether supervised losses have been generated for all tasks). If the criteria are not met, the method 400 returns to block 410 to continue training in a new stage, iteration, or epoch.

If the criteria are met, the method 400 continues to block 445, where the training system deploys the multitask model for inferencing (e.g., locally or to a dedicated inferencing system, such as the inferencing system 120 of FIG. 1).

Although depicted as an iterative process for conceptual clarity, in some aspects, some or all of the operations may be performed in parallel or in a different order. For example, in some aspects, the training system performs blocks 410 through 430 for each task (sequentially or in parallel) to generate task-specific combined losses, and then aggregates these task-specific losses to form an overall loss which is then used, at block 435, to update the model. In some aspects, the training system performs blocks 410 through 435 for each task (sequentially or in parallel) to generate task-specific combined losses and update the model for each.

In some aspects, rather than operating on a per-task basis (e.g., generating losses for each task independently), the training system selects an exemplar, generates supervised loss(es) for any labels associated with the selected exemplar, and generates self-supervised loss(es) for any other tasks before selecting the next exemplar. These individual losses may then be aggregated and used to refine the model.

Advantageously, by using the method 400, the training system leverages disjoint datasets with non-overlapping output labels to train a unified multitask machine learning model that is able to more accurately and reliably generate predictions for the relevant machine learning tasks while consuming fewer computational resources, as compared to conventional approaches.

### Example Method for Aggregating Losses to Train Multitask Machine Learning Models Using Disjoint Datasets

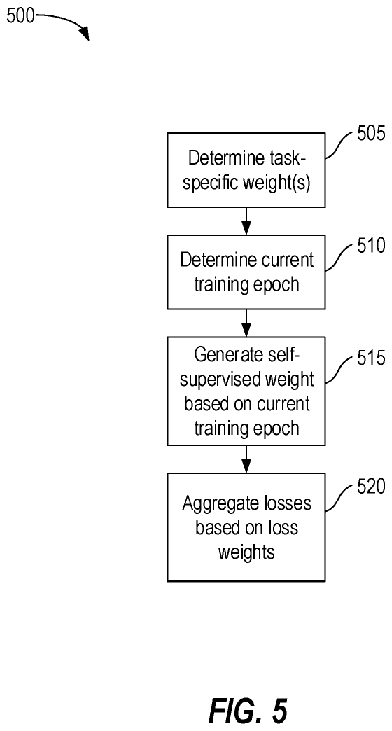

FIG. 5 is a flow diagram depicting an example method 500 for aggregating losses to train multitask machine learning models using disjoint datasets. In some aspects, the method 500 is performed by a training system, such as the training system 110 of FIG. 1. In some aspects, the method 500 provides additional detail for block 430 of FIG. 4.

At block 505, the training system determines task-specific weight(s) for one or more of the machine learning tasks. That is, for each given task, the training system may determine a corresponding task-specific weight. As discussed above, these task-specific weights may be fixed, static, or constant during training. The task-specific weights may be selected, for example, to account for domain imbalances (e.g., where one task dataset for a given task or domain has more exemplars than another).

At block 510, the training system determines the current epoch of the training process. For example, as discussed above, the training system may determine the number of the epoch (e.g., whether it is the first, third, or i-th epoch). In some aspects, the training system determines a category of the current epoch (e.g., whether it is classified or labeled as an early epoch, a middle epoch, or late epoch).

At block 515, the training system generates or determines a self-supervised weight based on the current epoch. For example, as discussed above, the training system may compute a weight using an equation that begins with a first defined value (e.g., zero) and gradually increases (linearly or exponentially) to a second defined value (e.g., one) based on the current epoch number. In some aspects, the training system may refer to a mapping or association indicating the appropriate self-supervised weight based on the current epoch.

At block 520, the training system then aggregates the losses based on the task-specific weight(s) and/or the self-supervised weight(s), as discussed above. These aggregated or combined weights can then be used to refine the machine learning model, as discussed above.

### Example Method for Training a Multitask Machine Learning Model

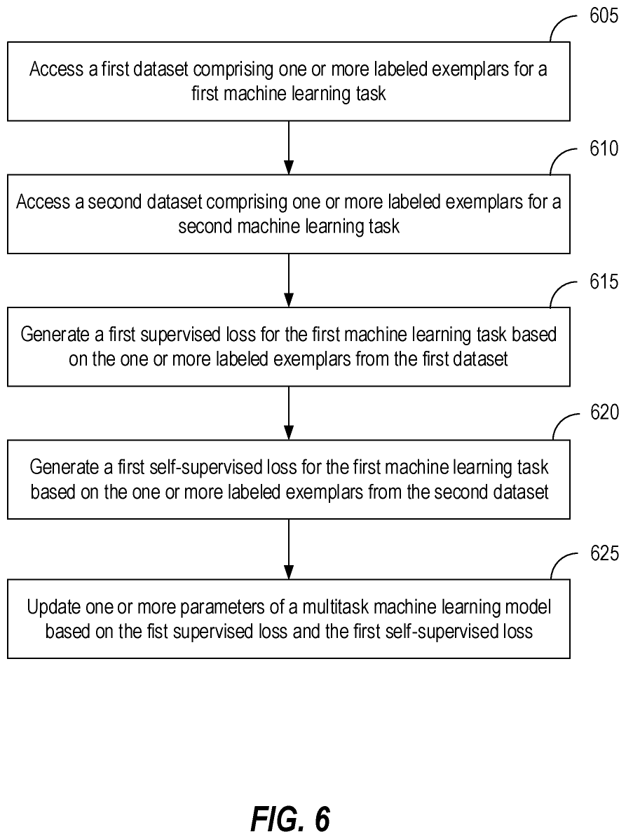

FIG. 6 is a flow diagram depicting an example method 600 for training a multitask machine learning model. In some aspects, the method 600 is performed by a training system, such as the training system 110 of FIG. 1.

At block 605, a first dataset comprising one or more labeled exemplars for a first machine learning task is accessed.

At block 610, a second dataset comprising one or more labeled exemplars for a second machine learning task is accessed.

At block 615, a first supervised loss for the first machine learning task is generated based on the one or more labeled exemplars from the first dataset.

At block 620, a first self-supervised loss for the first machine learning task is generated based on the one or more labeled exemplars from the second dataset.

In some aspects, a combined loss is generated based on the first supervised loss and the first self-supervised loss.

At block 625, one or more parameters of a multitask machine learning model are updated based on the combined loss.

In some aspects, generating the combined loss further comprises aggregating the first supervised loss and the first self-supervised loss based at least in part on a first weight for the first self-supervised loss, the first weight being determined based on a current epoch of training the multitask machine learning model.

In some aspects, the first weight is assigned a relatively lower value during relatively earlier epochs of training the multitask machine learning model, as compared to relatively later epochs of training the multitask machine learning model.

In some aspects, the first supervised loss and the first self-supervised loss are aggregated based further on a second weight for the first machine learning task, the second weight having a constant value during training of the multitask machine learning model.

In some aspects, generating the combined loss further comprises generating a second supervised loss for the second machine learning task based on the one or more labeled exemplars from the second dataset.

In some aspects, generating the combined loss further comprises generating a second self-supervised loss for the second machine learning task based on the one or more labeled exemplars from the first dataset.

In some aspects, generating the first self-supervised loss comprises, for a first labeled exemplar from the second dataset: generating a first output based on the first labeled exemplar augmented according to a first set of augmentations, generating a second output based on the first labeled exemplar augmented according to a second set of augmentations, generating a pseudo-label based on modifying the first output using the first and second sets of augmentations, and comparing the pseudo-label and the second output.

In some aspects, the multitask machine learning model comprises an encoder component shared by both the first and second machine learning tasks, a first decoder component for the first machine learning task, and a second decoder component for the second machine learning task.

In some aspects, the first and second machine learning tasks are computer vision tasks and comprise at least one of: monocular depth estimation, semantic segmentation, object detection, surface normal estimation, or edge detection.

### Example Processing System for Multitask Learning

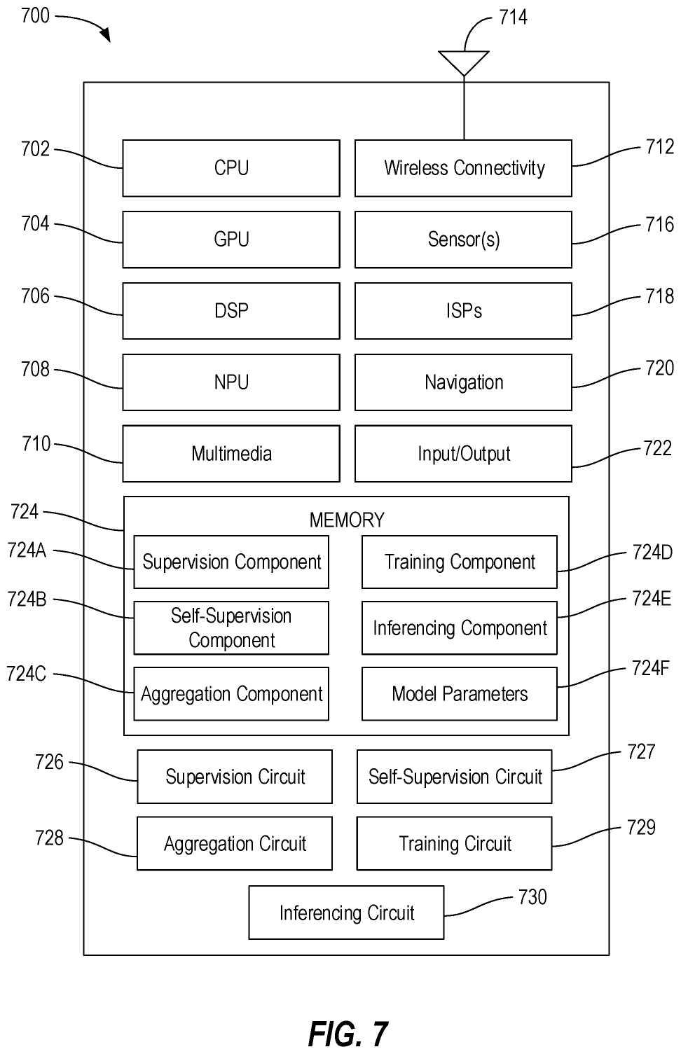

In some aspects, the workflows, techniques, and methods described with reference to FIGS. 1-6 may be implemented on one or more devices or systems. FIG. 7 depicts an example processing system 700 configured to perform various aspects of the present disclosure, including, for example, the techniques and methods described with respect to FIGS. 1-6. In some aspects, the processing system 700 may correspond to a training system, such as the training system 110 of FIG. 1, and/or an inferencing system, such as the inferencing system 120 of FIG. 1. For example, the processing system 700 may correspond to a machine learning system that trains multitask machine learning models, and/or that uses multitask machine learning models during runtime. Although depicted as a single system for conceptual clarity, in some aspects, as discussed above, the operations described below with respect to the processing system 700 may be distributed across any number of devices or systems.

The processing system 700 includes a central processing unit (CPU) 702, which in some examples may be a multi-core CPU. Instructions executed at the CPU 702 may be loaded, for example, from a program memory associated with the CPU 702 or may be loaded from a memory partition (e.g., a partition of memory 724).

The processing system 700 also includes additional processing components tailored to specific functions, such as a graphics processing unit (GPU) 704, a digital signal processor (DSP) 706, a neural processing unit (NPU) 708, a multimedia component 710 (e.g., a multimedia processing unit), and a wireless connectivity component 712.

An NPU, such as NPU 708, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system on a chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and/or other wireless data transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation processor 720, which may include satellite-based positioning system components (e.g., GPS or GLONASS), as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes a supervision component 724A, a self-supervision component 724B, an aggregation component 724C, a training component 724D, and an inferencing component 724E. The memory 724 further includes model parameters 724F for one or more models (e.g., the multitask machine learning model 115 of FIG. 1). Although not included in the illustrated example, in some aspects the memory 724 may also include other data, such as training data (e.g., the task datasets 105 of FIG. 1). Though depicted as discrete components for conceptual clarity in FIG. 7, the illustrated components (and others not depicted) may be collectively or individually implemented in various aspects.

The processing system 700 further comprises a supervision circuit 726, a self-supervision circuit 727, an aggregation circuit 728, a training circuit 729, and an inferencing circuit 730. The depicted circuits, and others not depicted, may be configured to perform various aspects of the techniques described herein.

For example, the supervision component 724A and/or the supervision circuit 726 (which may correspond to the supervision component 210 of FIG. 2) may be used to generate supervised losses for one or more machine learning tasks based on training data that is labeled for the given task, as discussed above. For example, the supervision component 724A and/or the supervision circuit 726 may generate a cross-entropy loss based on such labeled exemplars.

The self-supervision component 724B and/or the self-supervision circuit 727 (which may correspond to the self-supervision component 215 of FIG. 2) may be used to generate self-supervised losses for one or more machine learning tasks based on data that is not labeled for the given task, as discussed above. For example, the self-supervision component 724B and/or the self-supervision circuit 727 may use the workflow 300 to generate the self-supervised losses.

The aggregation component 724C and/or the aggregation circuit 728 (which may correspond to the aggregation component 230 of FIG. 2) may be used to aggregate losses to form combined or overall losses (e.g., the combined loss 235 of FIG. 2), as discussed above. For example, the aggregation component 724C and/or the aggregation circuit 728 may use one or more loss weights (e.g., task-specific weights and/or self-supervised weights) to compute a weighted sum of the losses for each task.

The training component 724D and/or the training circuit 729 may be used to update one or more parameters of machine learning models (e.g., the multitask machine learning model 115 of FIG. 1), as discussed above. For example, the training component 724D and/or the training circuit 729 may use generated and/or aggregated losses to refine the models (e.g., using backpropagation), and may otherwise control or manage the training process.

The inferencing component 724E and/or the inferencing circuit 730 may be used to generate output predictions (e.g., the task-specific predictions 130 of FIG. 1), as discussed above. For example, the inferencing component 724E and/or the inferencing circuit 730 may use trained multitask machine learning models to process input data and generate a set of predictions for one or more tasks.

Though depicted as separate components and circuits for clarity in FIG. 7, the supervision circuit 726, the self-supervision circuit 727, the aggregation circuit 728, the training circuit 729, and the inferencing circuit 730 may collectively or individually be implemented in other processing devices of the processing system 700, such as within the CPU 702, the GPU 704, the DSP 706, the NPU 708, and the like.

Generally, the processing system 700 and/or components thereof may be configured to perform the methods described herein.

Notably, in other aspects, elements of the processing system 700 may be omitted, such as where the processing system 700 is a server computer or the like. For example, the multimedia component 710, the wireless connectivity component 712, the sensor processing units 716, the ISPs 718, and/or the navigation processor 720 may be omitted in other aspects. Further, aspects of the processing system 700 may be distributed between multiple devices.

### Example Clauses

Implementation examples are described in the following numbered clauses:

Clause 1: A method, comprising: accessing a first dataset comprising one or more labeled exemplars for a first machine learning task; accessing a second dataset comprising one or more labeled exemplars for a second machine learning task; generating a combined loss based on the first and second datasets, comprising: generating a first supervised loss for the first machine learning task based on the one or more labeled exemplars from the first dataset; and generating a first self-supervised loss for the first machine learning task based on the one or more labeled exemplars from the second dataset; and updating one or more parameters of a multitask machine learning model based on the combined loss.

Clause 2: A method according to Clause 1, wherein generating the combined loss further comprises aggregating the first supervised loss and the first self-supervised loss based at least in part on a first weight for the first self-supervised loss, the first weight being determined based on a current epoch of training the multitask machine learning model.

Clause 3: A method according to Clause 2, wherein the first weight is assigned a relatively lower value during relatively earlier epochs of training the multitask machine learning model, as compared to relatively later epochs of training the multitask machine learning model.

Clause 4: A method according to Clause 2, wherein the first supervised loss and the first self-supervised loss are aggregated based further on a second weight for the first machine learning task, the second weight having a constant value during training of the multitask machine learning model.

Clause 5: A method according to any of Clauses 1-4, wherein generating the combined loss further comprises generating a second supervised loss for the second machine learning task based on the one or more labeled exemplars from the second dataset.

Clause 6: A method according to any of Clauses 1-5, wherein generating the combined loss further comprises generating a second self-supervised loss for the second machine learning task based on the one or more labeled exemplars from the first dataset.

Clause 7: A method according to any of Clauses 1-6, wherein generating the first self-supervised loss comprises, for a first labeled exemplar from the second dataset: generating a first output based on the first labeled exemplar augmented according to a first set of augmentations; generating a second output based on the first labeled exemplar augmented according to a second set of augmentations; generating a pseudo-label based on modifying the first output using the first and second sets of augmentations; and comparing the pseudo-label and the second output.

Clause 8: A method according to any of Clauses 1-7, wherein the multitask machine learning model comprises an encoder component shared by both the first and second machine learning tasks, a first decoder component for the first machine learning task, and a second decoder component for the second machine learning task.

Clause 9: A method according to any of Clauses 1-8, wherein the first and second machine learning tasks are computer vision tasks and comprise at least one of: monocular depth estimation, semantic segmentation, object detection, surface normal estimation, or edge detection.

Clause 10: A processing system comprising: a memory comprising computer-executable instructions; and one or more processors configured to execute the computer-executable instructions and cause the processing system to perform a method in accordance with any of Clauses 1-9.

Clause 11: A processing system comprising means for performing a method in accordance with any of Clauses 1-9.

Clause 12: A non-transitory computer-readable medium comprising computer-executable instructions that, when executed by one or more processors of a processing system, cause the processing system to perform a method in accordance with any of Clauses 1-9.

Clause 13: A computer program product embodied on a computer-readable storage medium comprising code for performing a method in accordance with any of Clauses 1-9.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system comprising:
a memory comprising computer-executable instructions; and
one or more processors configured to execute the computer-executable instructions and cause the processing system to:
access a first dataset comprising one or more labeled exemplars for a first machine learning task;
access a second dataset comprising one or more labeled exemplars for a second machine learning task;
generate a combined loss based on the first and second datasets, wherein to generate the combined loss, the one or more processors are configured to execute the computer-executable instructions to cause the processing system to:
generate a first supervised loss for the first machine learning task based on the one or more labeled exemplars from the first dataset; and
generate a first self-supervised loss for the first machine learning task based on the one or more labeled exemplars from the second dataset; and
update one or more parameters of a multitask machine learning model based on the combined loss.

2. The processing system of claim 1, wherein to generate the combined loss, the one or more processors are configured to execute the computer-executable instructions to cause the processing system to aggregate the first supervised loss and the first self-supervised loss based at least in part on a first weight for the first self-supervised loss, the first weight being determined based on a current epoch of training the multitask machine learning model.

3. The processing system of claim 2, wherein the first weight is assigned a relatively lower value during relatively earlier epochs of training the multitask machine learning model, as compared to relatively later epochs of training the multitask machine learning model.

4. The processing system of claim 2, wherein the first supervised loss and the first self-supervised loss are aggregated based further on a second weight for the first machine learning task, the second weight having a constant value during training of the multitask machine learning model.

5. The processing system of claim 1, wherein to generate the combined loss, the one or more processors are configured to execute the computer-executable instructions to cause the processing system to generate a second supervised loss for the second machine learning task based on the one or more labeled exemplars from the second dataset.

6. The processing system of claim 1, wherein to generate the combined loss, the one or more processors are configured to execute the computer-executable instructions to cause the processing system to generate a second self-supervised loss for the second machine learning task based on the one or more labeled exemplars from the first dataset.

7. The processing system of claim 1, wherein to generate the first self-supervised loss, the one or more processors are configured to execute the computer-executable instructions to cause the processing system to, for a first labeled exemplar from the second dataset:
generate a first output based on the first labeled exemplar augmented according to a first set of augmentations;
generate a second output based on the first labeled exemplar augmented according to a second set of augmentations;
generate a pseudo-label based on modifying the first output using the first and second sets of augmentations; and
compare the pseudo-label and the second output.

8. The processing system of claim 1, wherein the multitask machine learning model comprises an encoder component shared by both the first and second machine learning tasks, a first decoder component for the first machine learning task, and a second decoder component for the second machine learning task.

9. The processing system of claim 1, wherein the first and second machine learning tasks are computer vision tasks and comprise at least one of: monocular depth estimation, semantic segmentation, object detection, surface normal estimation, or edge detection.

10. A processor-implemented method, comprising:
accessing a first dataset comprising one or more labeled exemplars for a first machine learning task;
accessing a second dataset comprising one or more labeled exemplars for a second machine learning task;
generating a combined loss based on the first and second datasets, comprising:
generating a first supervised loss for the first machine learning task based on the one or more labeled exemplars from the first dataset; and
generating a first self-supervised loss for the first machine learning task based on the one or more labeled exemplars from the second dataset; and
updating one or more parameters of a multitask machine learning model based on the combined loss.

11. The processor-implemented method of claim 10, wherein generating the combined loss further comprises aggregating the first supervised loss and the first self-supervised loss based at least in part on a first weight for the first self-supervised loss, the first weight being determined based on a current epoch of training the multitask machine learning model.

12. The processor-implemented method of claim 11, wherein the first weight is assigned a relatively lower value during relatively earlier epochs of training the multitask machine learning model, as compared to relatively later epochs of training the multitask machine learning model.

13. The processor-implemented method of claim 11, wherein the first supervised loss and the first self-supervised loss are aggregated based further on a second weight for the first machine learning task, the second weight having a constant value during training of the multitask machine learning model.

14. The processor-implemented method of claim 10, wherein generating the combined loss further comprises generating a second supervised loss for the second machine learning task based on the one or more labeled exemplars from the second dataset.

15. The processor-implemented method of claim 10, wherein generating the combined loss further comprises generating a second self-supervised loss for the second machine learning task based on the one or more labeled exemplars from the first dataset.

16. The processor-implemented method of claim 10, wherein generating the first self-supervised loss comprises, for a first labeled exemplar from the second dataset:
generating a first output based on the first labeled exemplar augmented according to a first set of augmentations;
generating a second output based on the first labeled exemplar augmented according to a second set of augmentations;
generating a pseudo-label based on modifying the first output using the first and second sets of augmentations; and
comparing the pseudo-label and the second output.

17. The processor-implemented method of claim 10, wherein the multitask machine learning model comprises an encoder component shared by both the first and second machine learning tasks, a first decoder component for the first machine learning task, and a second decoder component for the second machine learning task.

18. The processor-implemented method of claim 10, wherein the first and second machine learning tasks are computer vision tasks and comprise at least one of: monocular depth estimation, semantic segmentation, object detection, surface normal estimation, or edge detection.

19. A non-transitory computer-readable medium comprising computer-executable instructions that, when executed by one or more processors of a processing system, cause the processing system to:
access a first dataset comprising one or more labeled exemplars for a first machine learning task;
access a second dataset comprising one or more labeled exemplars for a second machine learning task;
generate a combined loss based on the first and second datasets, wherein to generate the combined loss, the one or more processors are configured to execute the computer-executable instructions to cause the processing system to:
generate a first supervised loss for the first machine learning task based on the one or more labeled exemplars from the first dataset; and
generate a first self-supervised loss for the first machine learning task based on the one or more labeled exemplars from the second dataset; and
update one or more parameters of a multitask machine learning model based on the combined loss.

20. The non-transitory computer-readable medium of claim 19, wherein to generate the combined loss, the one or more processors are configured to execute the computer-executable instructions to cause the processing system to aggregate the first supervised loss and the first self-supervised loss based at least in part on a first weight for the first self-supervised loss, the first weight being determined based on a current epoch of training the multitask machine learning model.

21. The non-transitory computer-readable medium of claim 20, wherein the first weight is assigned a relatively lower value during relatively earlier epochs of training the multitask machine learning model, as compared to relatively later epochs of training the multitask machine learning model.

22. The non-transitory computer-readable medium of claim 20, wherein the first supervised loss and the first self-supervised loss are aggregated based further on a second weight for the first machine learning task, the second weight having a constant value during training of the multitask machine learning model.

23. The non-transitory computer-readable medium of claim 19, wherein to generate the combined loss, the one or more processors are configured to execute the computer-executable instructions to cause the processing system to generate a second supervised loss for the second machine learning task based on the one or more labeled exemplars from the second dataset.

24. The non-transitory computer-readable medium of claim 19, wherein to generate the combined loss, the one or more processors are configured to execute the computer-executable instructions to cause the processing system to generate a second self-supervised loss for the second machine learning task based on the one or more labeled exemplars from the first dataset.

25. The non-transitory computer-readable medium of claim 19, wherein to generate the first self-supervised loss, the one or more processors are configured to execute the computer-executable instructions to cause the processing system to, for a first labeled exemplar from the second dataset:
generate a first output based on the first labeled exemplar augmented according to a first set of augmentations;
generate a second output based on the first labeled exemplar augmented according to a second set of augmentations;
generate a pseudo-label based on modifying the first output using the first and second sets of augmentations; and
compare the pseudo-label and the second output.

26. The non-transitory computer-readable medium of claim 19, wherein the multitask machine learning model comprises an encoder component shared by both the first and second machine learning tasks, a first decoder component for the first machine learning task, and a second decoder component for the second machine learning task.

27. The non-transitory computer-readable medium of claim 19, wherein the first and second machine learning tasks are computer vision tasks and comprise at least one of: monocular depth estimation, semantic segmentation, object detection, surface normal estimation, or edge detection.

28. A processing system, comprising:
means for accessing a first dataset comprising one or more labeled exemplars for a first machine learning task;
means for accessing a second dataset comprising one or more labeled exemplars for a second machine learning task;
means for generating a combined loss based on the first and second datasets, comprising:
means for generating a first supervised loss for the first machine learning task based on the one or more labeled exemplars from the first dataset; and
means for generating a first self-supervised loss for the first machine learning task based on the one or more labeled exemplars from the second dataset; and
means for updating one or more parameters of a multitask machine learning model based on the combined loss.

29. The processing system of claim 28, wherein the means for generating the combined loss comprises means for aggregating the first supervised loss and the first self-supervised loss based at least in part on a first weight for the first self-supervised loss, the first weight being determined based on a current epoch of training the multitask machine learning model.

30. The processing system of claim 28, wherein the means for generating the combined loss comprise:
means for generating a second supervised loss for the second machine learning task based on the one or more labeled exemplars from the second dataset; and
means for generating a second self-supervised loss for the second machine learning task based on the one or more labeled exemplars from the first dataset.
